(19) United States
(12) Patent Application Publication
(10) Pub. No.: US 2024/0340068 A1
(43) Pub. Date: Oct. 10, 2024

(54) METHODS AND APPARATUSES FOR TRP RELATED BEAM FAILURE DETECTION AND RECOVERY PROCEDURES

(71) Applicant: Lenovo (Beijing) Limited, Beijing (CN)

(72) Inventors: Lianhai Wu, Beijing (CN); Bingchao Liu, Beijing (CN); Ran Yue, Beijing (CN); Jing Han, Beijing (CN); Haiming Wang, Beijing (CN)

(73) Assignee: Lenovo (Beijing) Limited, Beijing (CN)

(21) Appl. No.: 18/579,452

(22) PCT Filed: Jul. 29, 2021
(86) PCT No.: PCT/CN2021/109358

§ 371 Date: Jan. 15, 2024

(51) Int. Cl. H04B 7/06; H04L 1/1829; H04W 36/00; H04W 72/23; H04W 74/0833; H04W 76/19

(52) U.S. Cl. CPC H04B 7/06964; H04L 1/1864; H04W 36/0083; H04W 72/23; H04W 74/0833; H04W 76/19

(57) ABSTRACT

Embodiments of the present application relate to methods and apparatuses for a transmission reception point (TRP) related beam failure detection and recovery procedures under a 3rd Generation Partnership Project (3GPP) 5G system or the like. According to an embodiment of the present application, a method can be performed by a user equipment (UE) and include: receiving, from a serving cell, configuration information related to at least one transmission reception point (TRP) of the serving cell; detecting a beam failure of a TRP; and triggering a beam failure recovery (BFR) procedure, wherein the BFR procedure includes transmitting a BFR request to the serving cell, and wherein the BFR request includes information per TRP associated with the at least one TRP of the serving cell. If the configuration information is related to at least two TRPs of the serving cell, before transmitting the BFR request, the UE may detect a further beam failure of a further TRP. The UE may trigger a further BFR procedure.

### TECHNICAL FIELD

Embodiments of the present application generally relate to wireless communication technology, especially to methods and apparatuses for a transmission reception point (TRP) related beam failure detection and recovery procedures.

### BACKGROUND

Currently, 3rd Generation Partnership Project (3GPP) RAN2 has agreed the common understanding for a scenario including at least one TRP configured to a serving cell in RAN2 #114 meeting. However, several issues related to a beam failure detection procedure or a beam failure recovery procedure with TRP has not been discussed in 3GPP 5G technology yet and the corresponding solutions have not been specified.

### SUMMARY

Some embodiments of the present application provide a method performed by a UE. The method includes: receiving, from a serving cell, configuration information related to at least one TRP of the serving cell; detecting a beam failure of a TRP; and triggering a beam failure recovery (BFR) procedure, wherein the BFR procedure includes transmitting a BFR request to the serving cell, and wherein the BFR request includes information per TRP associated with the at least one TRP of the serving cell.

Some embodiments of the present application also provide a UE. The UE includes a processor and a wireless transceiver coupled to the processor; and the processor is configured: to receive, via the wireless transceiver from a serving cell, configuration information related to at least one TRP of the serving cell; to detect a beam failure of a TRP; and to trigger a BFR procedure, wherein the BFR procedure includes transmitting a BFR request to the serving cell, and wherein the BFR request includes information per TRP associated with the at least one TRP of the serving cell.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a UE.

Some embodiments of the present application provide a method performed by a network device (e.g., a base station (BS)). The method includes: transmitting, to a UE, configuration information related to at least one TRP of a serving cell of the UE; and receiving, from the UE, a BFR request, wherein the BFR request includes information per TRP associated with the at least one TRP.

Some embodiments of the present application also provide a network device (e.g., a BS). The network device includes a processor and a wireless transceiver coupled to the processor; and the processor is configured: to transmit, via the wireless transceiver to a UE, configuration information related to at least one TRP of a serving cell of the UE; and to receive, via the wireless transceiver from the UE, a BFR request, wherein the BFR request includes information per TRP associated with the at least one TRP.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a network device (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates scenarios on an inter-cell operation in accordance with some embodiments of the present application;

FIG. 2 illustrates a flow chart of a method for triggering a BFR procedure in accordance with some embodiments of the present application;

FIG. 3 illustrates a flow chart of a method for receiving a BFR request in accordance with some embodiments of the present application;

FIGS. 4 and 5 illustrate two exemplary format diagrams of a BFR MAC CE in accordance with 3GPP standard document TS38.321;

FIG. 6 illustrates an exemplary format diagram of a TRP based BFR MAC CE with only one TRP for each failed cell in accordance with some embodiments of the present application;

FIG. 7A illustrates an exemplary format diagram of a TRP based BFR MAC CE with same cell indication and one octet Cᵢ field in accordance with some embodiments of the present application;

FIG. 7B illustrates an exemplary format diagram of a TRP based BFR MAC CE with same cell indication and four octet Cᵢ field in accordance with some embodiments of the present application; and

FIG. 8 illustrates an exemplary format diagram of a TRP based BFR MAC CE with a total number of failed TRP(s) in accordance with some embodiments of the present application;

FIG. 9 illustrates an exemplary format diagram of a TRP based BFR MAC CE with a FI field in accordance with some embodiments of the present application;

FIG. 10 illustrates an exemplary format diagram of a TRP based BFR MAC CE with or without TRP configuration in accordance with some embodiments of the present application; and

FIG. 11 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

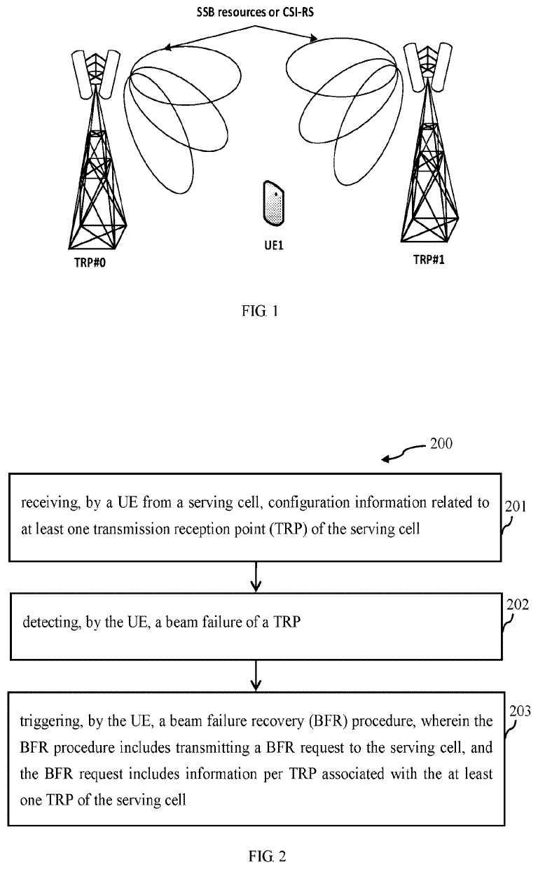

FIG. 1 illustrates scenarios on an inter-cell operation in accordance with some embodiments of the present application.

In some cases, UE1 may receive, from a serving cell, configuration(s) of SSB(s) or a channel state information reference signal (CSI-RS) of a TRP (e.g., TRP #0 and/or TRP #1) with a physical layer identifier (PCID) for a beam measurement and resource configuration(s) for data transmission or data reception associated with the PCID. UE1 performs a beam measurement for the TRP with the PCID and reports a measurement result to the serving cell. Based on the above reports, transmission configuration indicator (TCI) state(s) associated with the TRP with the PCID is activated from the serving cell (by Layer 1 signaling or Layer 2 signaling). A TCI may be a synchronization signal block (SSB) or a channel state information reference signal (CSI-RS). UE1 receives and transmits using a UE-dedicated channel on the TRP with the PCID. UE1 should be in coverage of a serving cell always, also for a multi-TRP case, e.g., UE1 should use common channels broadcast control channel (BCCH), paging control channel (PCCH), etc., from the serving cell. As shown in FIG. 1, UE1 is served by TRP #0 and TRP #1. UE1 can receive data from TRP #0 and TRP #1 at the same time.

In some embodiments of the present application, UE1 as shown in FIG. 1 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., TRPs, routers, switches, and modems), or the like. In some other embodiments of the present application, UE1 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE1 may include wearable devices, such as smart watches, fitness bands, optical head-mounted displays, or the like. Moreover, UE1 may be referred to as a subscriber unit, a mobile, a mobile station, a user, a terminal, a mobile terminal, a wireless terminal, a fixed terminal, a subscriber station, a user terminal, or a device, or described using other terminology used in the art.

Currently, more details regarding a UE's behavior and a BS's behavior in the above scenario are unclear, several common issues have not been solved, and different solutions are needed in the different cases. Some embodiments of the subject application aim to provide solutions for a case that both TRP beam failures of a secondary cell (SCell) are detected at the same time. Some embodiments of the subject application aim to provide solutions for a case that both TRP beam failures of a primary cell (PCell) or a primary cell of a second cell group (PSCell) are detected at the same time. Some embodiments of the subject application aim to provide solutions for a TRP based BFR MAC CE and the corresponding UE's behavior, e.g., a cancellation mechanism. More details regarding embodiments of the present application will be illustrated in the following text in combination with the appended drawings.

FIG. 2 illustrates a flow chart of a method for triggering a BFR procedure in accordance with some embodiments of the present application. The exemplary method 200 in the embodiments of FIG. 2 may be performed by a UE, e.g., UE1 as shown and illustrated in FIG. 1. Although described with respect to a UE, it should be understood that other device(s) may be configured to perform the method as shown and illustrated in FIG. 2. Specific examples of the embodiments of FIG. 2 are described in Embodiments 1-4 as below.

In the exemplary method 200 as shown in FIG. 2, in operation 201, a UE receives, from a serving cell, configuration information related to at least one TRP of the serving cell. In operation 202, the UE detects a beam failure of a TRP. In operation 203, the UE triggers a BFR procedure, wherein the BFR procedure includes transmitting a BFR request to the serving cell, and wherein the BFR request includes information per TRP associated with the at least one TRP of the serving cell.

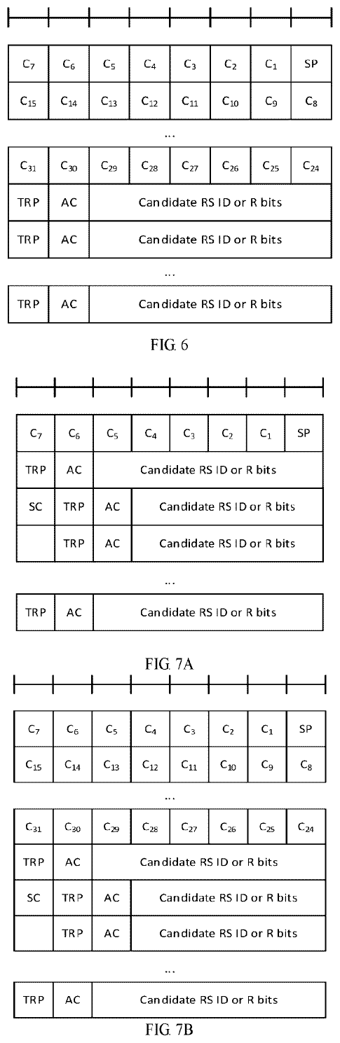

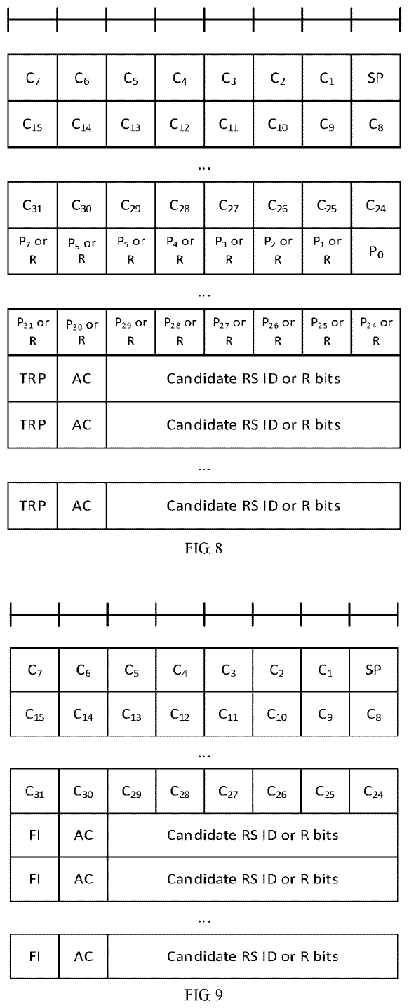

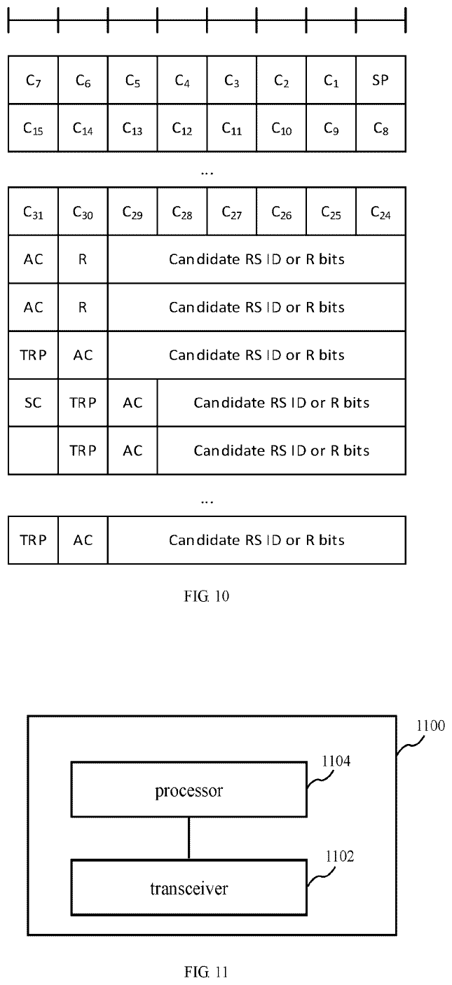

According to some embodiments, the BFR request includes information related to the TRP, and the BFR request is included in a medium access control (MAC) control element (CE). According to some embodiments, the BFR request includes at least one of:
(1) a field of a TRP identifier (ID), e.g., “TRP” field as shown in FIGS. 6, 7A, 7B, and 8-10;
(2) a field of a total number of TRP(s) which occur a beam failure, e.g., “Pi” field as shown in FIG. 8;
(3) a field indicating whether a TRP is failed or not, e.g., “FI” field as shown in FIG. 9; and
(4) a field indicating whether a subsequent TRP in a MAC CE of the BFR request is associated with the same cell as a previous TRP in the MAC CE or not, e.g., “SC” field as shown in FIGS. 7A, 7B, and 10.

According to some embodiments, the configuration information is related to at least two TRPs of the serving cell. Before transmitting the BFR request to the serving cell to the serving cell, the UE may detect a further beam failure of a further TRP, and the UE may trigger a further BFR procedure, wherein the further BFR procedure includes transmitting a further BFR request to the serving cell. For example, the further BFR request is included in a further MAC CE. In an embodiment, both the MAC CE and the further MAC CE can be included in one packet data unit (PDU).

In some embodiments, the UE receives, from a network, configuration information related to two secondary cell groups (SCGs), and these two SCGs are configured for one distributed unit (DU). If one SCG within these two SCGs is configured a TRP, the MAC CE and/or the further MAC CE are associated with one or more serving cells of the one SCG. If each SCG of the two SCGs is configured a TRP, the MAC CE and/or the further MAC CE are associated with one or more serving cells of each SCG of the two SCGs.

In some embodiments, the further BFR request may include information related to a failed TRP among the TRP and the further TRP. In an embodiment, if the further BFR request is a failed TRP and if the further BFR request includes information related to the further TRP, the UE may:
(5) transmit the BFR request and not cancel the further BFR request; or
(6) transmit the further BFR request and not cancel the BFR request; or
(7) transmit the BFR request and cancel the further BFR request, if the BFR request has a higher priority level than the further BFR request; or
(8) transmit the further BFR request and cancel the BFR request, if the further BFR request has a higher priority level than the BFR request.

In a further embodiment, if both the TRP and the further TRP are failed TRPs and if the further BFR request includes both information related to the TRP and information related to the further TRP, the UE may:
(1) transmit the further BFR request and not cancel the BFR request, if the UE triggers the further BFR procedure; or
(2) transmit the further BFR request and cancel the BFR request, if the UE triggers the further BFR procedure; or
(3) transmit the BFR request and not cancel the further BFR request.

For example, if the BFR request has a higher priority level than the BFR request and if the UE triggers the further BFR procedure, the UE transmits the further BFR request and does not cancel the BFR request.

In these embodiments, the serving cell may be a SCell; a PCell; or a PSCell. In an embodiment, if the serving cell is the PCell or the PSCell and if the configuration information is related to at least two TRPs of the serving cell, the configuration information related to the at least two TRPs includes: (1) an association relationship between “a beam failure detection reference signal (BFD-RS) set configured for the TRP within the at least two TRPs” and “a reference signal (RS) set for a random access (RA) for a BFR procedure”; and (2) an association relationship between “a further BFD-RS set configured for the further TRP within the at least two TRPs” and “the RS set for the RA for the BFR procedure.” In a further embodiment, if the serving cell is the PCell or the PSCell, the UE transmits the BFR request and/or the further BFR request via an available serving cell.

In another embodiment, if the serving cell is the PCell or the PSCell, the UE monitors a physical downlink control channel (PDCCH) within a period. For example, if the UE receives the PDCCH within the period and if the PDCCH includes the same hybrid automatic repeat request (HARQ) process identifier (ID) as a physical uplink share channel (PUSCH) carrying a BFR MAC-CE, the UE considers that a BFR procedure for the serving cell is successful. If the UE does not receive the PDCCH within the period, the UE may perform a radio resource control (RRC) re-establishment procedure for the serving cell.

Details described in all other embodiments of the present application (for example, details regarding TRP related beam failure detection and recovery procedures) are applicable for the embodiments of FIG. 2. Moreover, details described in the embodiments of FIG. 2 are applicable for all the embodiments of FIGS. 1 and 3-11.

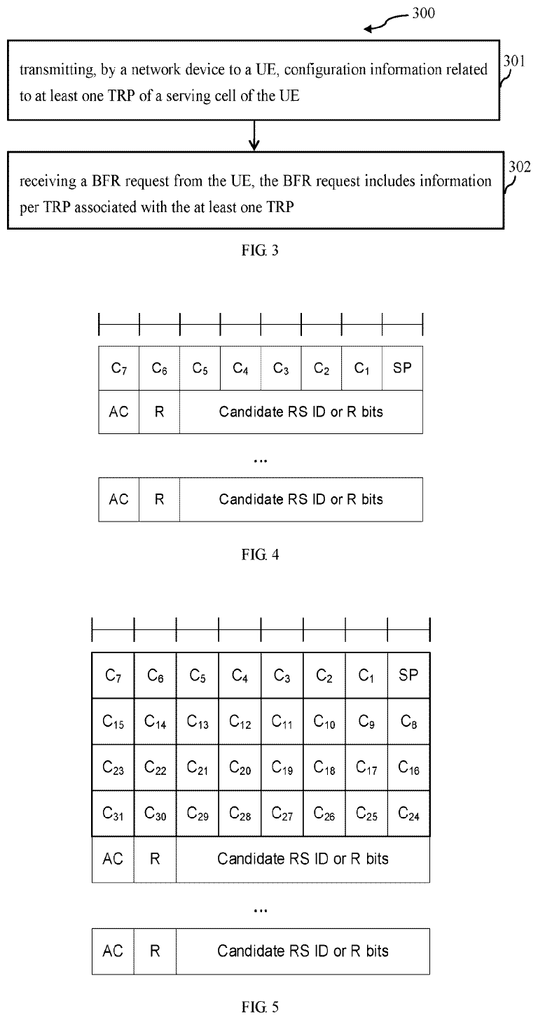

FIG. 3 illustrates a flow chart of a method for receiving a BFR request in accordance with some embodiments of the present application. The exemplary method 300 in the embodiments of FIG. 3 may be performed by a network device, e.g., a BS. Although described with respect to a network device, it should be understood that other device(s) may be configured to perform the method as shown and illustrated in FIG. 3. Specific examples of the embodiments of FIG. 3 are described in Embodiments 1-4 as below.

In the exemplary method 300 as shown in FIG. 3, in operation 301, a network device (e.g., a BS) transmits, to a UE (e.g., UE1 as shown and illustrated in FIG. 1), configuration information related to at least one TRP of a serving cell of the UE. In these embodiments, the serving cell may be a SCell; a PCell; or a PSCell. In an embodiment, if the serving cell is the PCell or the PSCell and if the configuration information is related to at least two TRPs of the serving cell, the configuration information related to at least two TRPs includes: (1) an association relationship between “a BFD-RS set configured for a TRP” and “a RS set for a RA for a BFR procedure”; and (2) an association relationship between “a further BFD-RS set configured for a further TRP” and “the RS set for the RA for the BFR procedure.”

In operation 302, the network device receives a BFR request from the UE. The BFR request includes information per TRP associated with the at least one TRP. If the configuration information is related to at least two TRPs of the serving cell, the BFR request may include information related to a failed TRP among the at least two TRPs. In some embodiments, the BFR request is included in a MAC CE. The MAC CE can be included in a PDU.

According to some embodiments, the BFR request includes at least one of:
(1) a field of a TRP identifier (ID), e.g., “TRP” field as shown in FIGS. 6, 7A, 7B, and 8-10;
(2) a field of a total number of at least one TRP occurring a beam failure, e.g., “Pi” field as shown in FIG. 8;
(3) a field indicating whether a TRP is failed or not, e.g., “FI” field as shown in FIG. 9; and
(4) a field indicating whether a subsequent TRP in a MAC CE of the BFR request is associated with the same cell as a previous TRP in the MAC CE or not, e.g., “SC” field as shown in FIGS. 7A, 7B, and 10.

According to some embodiments, the network device transmits, to the UE, configuration information related to two secondary cell groups (SCGs). These two SCGs are configured for one distributed unit (DU). If one SCG within these two SCGs is configured a TRP, the MAC CE is associated with one or more serving cells of the one SCG. If each SCG of these two SCGs is configured a TRP, the MAC CE is associated with one or more serving cells of each SCG of these two SCGs.

Details described in all other embodiments of the present application (for example, details regarding TRP related beam failure detection and recovery procedures) are applicable for the embodiments of FIG. 3. Moreover, details described in the embodiments of FIG. 3 are applicable for all the embodiments of FIGS. 1, 2, and 4-11.

FIGS. 4 and 5 illustrate two exemplary format diagrams of a BFR MAC CE in accordance with 3GPP standard document TS38.321. In the embodiments of FIGS. 4 and 5, fields in a BFR MAC CE are defined as follows:
SP (e.g., “SP” as shown in the eighth column, the first row of FIGS. 4 and 5, respectively): this field indicates beam failure detection for the SpCell of this MAC entity. The SP field is set to 1 to indicate that a beam failure is detected for a SpCell only when a BFR MAC CE is to be included into a MAC PDU as a part of a random access (RA) procedure; otherwise, the SP field is set to 0.
Cᵢ (BFR MAC CE) (e.g., “C₁” to “C₇” as shown in FIG. 4; and “C₁” to “C₃₁” as shown in FIG. 5): this field indicates BFD and the presence of an octet containing the AC field for the SCell with ServCellIndex i as specified in 3GPP standard document TS38.331. The Cᵢ field set to 1 indicates that a beam failure is detected and the octet containing the AC field is presented for the SCell with ServCellIndex i. The Cᵢ field set to 0 indicates that the beam failure is not detected and octet containing the AC field is not presented for the SCell with ServCellIndex i. The octets containing the AC field are present in an ascending order based on the ServCellIndex.
AC (e.g., “AC” as shown in the first column, the second row to the bottom row of FIG. 4; and “AC” as shown in the first column, the fifth row to the bottom row of FIG. 5): this field indicates the presence of the Candidate reference signal identifier (RS ID) field in this octet. If at least one of the SSBs with SS-RSRP above rsrp-ThresholdBFR amongst the SSBs in candidateBeamRSSCellList or the CSI-RSs with CSI-RSRP above rsrp-ThresholdBFR amongst the CSI-RSs in candidate BeamRSSCellList is available, the AC field is set to 1; otherwise, the AC field is set to 0. If the AC field set to 1, the Candidate RS ID field is present. If the AC field set to 0, R bits are present instead.
Candidate RS ID (e.g., “Candidate RS ID” as shown in the second row to the bottom row of FIG. 4; and “Candidate RS ID” as shown in the fifth row to the bottom row of FIG. 5): this field is set to the index of an SSB with SS-RSRP above rsrp-ThresholdBFR amongst the SSBs in candidateBeamRSSCellList or to the index of a CSI-RS with CSI-RSRP above rsrp-ThresholdBFR amongst the CSI-RSs in candidate BeamRSSCellList. Index of an SSB or CSI-RS is the index of an entry in candidateBeamRSSCellList corresponding to the SSB or CSI-RS. Index 0 corresponds to the first entry in candidateBeamRSSCellList, and index 1 corresponds to the second entry in the list and so on. The length of this field is 6 bits.
R (e.g., “R” as shown in the second row to the bottom row of FIG. 4; and “R” as shown in the fifth row to the bottom row of FIG. 5): this field is a reserved bit, and it is set to 0.

According to agreements of 3GPP standard document TS38.321, for a BFR procedure for a PSCell, if a beam failure instance indication has been received from a physical layer, a UE starts or restarts the beamFailureDetectionTimer and increment BFI_COUNTER by 1. If BFI_COUNTER>=beamFailureInstanceMaxCount and the serving cell is a PSCell or a PCell, the UE triggers a RA procedure on the SpCell. The UE selects a suitable beam to perform a BFR procedure (if the BS has provided dedicated RA resources for certain beams, those will be prioritized by the UE). Upon completing the RA procedure, the BFR procedure is considered as complete.

Embodiments of the present application introduce new formats of a BFR MAC CE associated with a TRP, which may also be named as “a TRP based BFR MAC CE”, “a TRP BFR MAC CE”, or the like. Some embodiments of the present application assume that each cell is configured with at least one TRP, e.g., two TRPs. Although a specific number of TRPs in a cell are depicted in some embodiments, it is contemplated that any number of TRPs may be configured to a cell. For example, one TRP may be configured to a cell in some embodiments, and three or more TRPs may be configured to a cell in some other embodiments. More details regarding new formats of a TRP based BFR MAC CE are described in FIGS. 6-10, respectively.

FIG. 6 illustrates an exemplary format diagram of a TRP based BFR MAC CE with only one TRP for each failed cell in accordance with some embodiments of the present application.

In the embodiments of FIG. 6, TRP information will be included for the corresponding candidate RS ID, and information regarding only one TRP of each failed cell can be included in a TRP based BFR MAC CE. Fields in a TRP based BFR MAC CE as shown in FIG. 6 are defined as follows:
SP (e.g., “SP” as shown in the eighth column, the first row of FIG. 6): this field indicates beam failure detection for the SpCell of this MAC entity. The SP field is set to 1 to indicate that a beam failure is detected for a SpCell only when a BFR MAC CE is to be included into a MAC PDU as a part of a random access (RA) procedure; otherwise, the SP field is set to 0.
Cᵢ (BFR MAC CE) (e.g., “C₁” to “C₃₁” as shown in FIG. 6): This field indicates beam failure detection in at least one TRP and the presence of an octet containing the AC field for the SCell with Serving Cell Index i. The Cᵢ field set to 1 indicates that beam failure for at least one TRP is detected, the evaluation of the candidate beams according to the requirements has been completed, and the octet containing the AC field is present for the SCell with Serving Cell Index i. The Cᵢ field set to 0 indicates that the beam failure is either not detected for all configured TRPs of this SCell or the beam failure is detected but the evaluation of the candidate beams according to the requirements has not been completed for all configured TRPs of this SCell. The octets containing the AC field are present in an ascending order based on the Serving Cell Index.
TRP (e.g., “TRP” as shown in the first column, the fifth row to the bottom row of FIG. 6): This field indicates TRP ID in which beam failure for this TRP is detected. And the evaluation of the candidate beams according to the requirements has been completed. TRP ID can be identified by BFD-RS set or CORESET pool. For example, if the TRP field is set to 0, it means that the TRP with an ID=0 (e.g., TRP #0 as shown in FIG. 1) fails; if the TRP field is set to 1, it means that the TRP with an ID=1 (e.g., TRP #1 as shown in FIG. 1) fails; or vice versa.
AC (e.g., “AC” as shown in the second column, the fifth row to the bottom row of FIG. 6): This field indicates the presence of the Candidate RS ID field in this octet. If at least one of the SSBs or the CSI-RSs is available, the AC field is set to 1; otherwise, it is set to 0. If the AC field set to 1, the Candidate RS ID field is present. If the AC field set to 0, R bits are present instead.
Candidate RS ID (e.g., “Candidate RS ID” as shown in the fifth row to the bottom row of FIG. 6): This field is set to the index of an SSB or the index of a CSI-RS. Index of an SSB or CSI-RS is the index of an entry in candidate Beam List corresponding to the SSB or CSI-RS. Index 0 corresponds to the first entry in the candidate Beam List, index 1 corresponds to the second entry in the list and so on. The length of this field is 6 bits.
R (e.g., “R” as shown in the fifth row to the bottom row of FIG. 6): Reserved bit, which is set to 0.

In one embodiment of FIG. 6, in a TRP based BFR MAC CE, C₁, C₂, C₃, and C₂₈ are set to 1, to mean that beam failures occur in four cells, i.e., at least one TRP in cells C₁, C₂, C₃, and C₂₈ are failed. Other Cᵢ fields are set to 0. “TRP” in the fifth row of FIG. 6 is set to an ID of TRP #x (e.g., TRP #0 as shown in FIG. 1) which is associated with cell C₁. “TRP” in the sixth row of FIG. 6 is set to an ID of TRP #y which is associated with cell C₂. “TRP” in the seventh row of FIG. 6 is set to an ID of TRP #m which is associated with cell C₃. “TRP” in the eighth row of FIG. 6 is set to an ID of TRP #n which is associated with cell C₂₈. In this embodiment, even if any cell within cells C₁, C₂, C₃, and C₂₈ includes two or more failed TRPs, information related to only one failed TRP of this cell is selected and filled in the “TRP” field corresponding to this cell.

In a further embodiment of FIG. 6, in a TRP based BFR MAC CE, C₄, C₉, C₂₃, C₂₇, and C₂₈ are set to 1, to mean that beam failures occur in five cells, i.e., at least one TRP of cells C₄, C₉, C₂₃, C₂₇, and C₂₈ are failed. Other Cᵢ fields are set to 0. “TRP” in the fifth row of FIG. 6 is set to an ID of TRP #x which is associated with cell C₄. “TRP” in the sixth row of FIG. 6 is set to an ID of TRP #y which is associated with cell C₉. “TRP” in the seventh row of FIG. 6 is set to an ID of TRP #m which is associated with cell C₂₃. “TRP” in the eighth row of FIG. 6 is set to an ID of TRP #n which is associated with cell C₂₇. “TRP” in the ninth row of FIG. 6 is set to an ID of TRP #n which is associated with cell C₂₈. In this embodiment, even if any cell within cells C₄, C₉, C₂₃, C₂₇, and C₂₈ includes two or more failed TRPs, information related to only one failed TRP of this cell is selected and filled in the “TRP” field corresponding to this cell.

FIG. 7A illustrates an exemplary format diagram of a TRP based BFR MAC CE with same cell indication and one octet Cᵢ field in accordance with some embodiments of the present application.

In the embodiments of FIG. 7A, TRP information will be included for the corresponding candidate RS ID. Information related to more than one TRP can be included in the TRP based BFR MAC CE. A main issue is how many candidate RS IDs of one cell should be indicated in the MAC CE, e.g., a one-bit indication can be used to indicate whether a next candidate RS ID belongs to the same cell or not. Fields in a TRP based BFR MAC CE as shown in FIG. 7A are defined as follows:
SP (e.g., “SP” as shown in the eighth column, the first row of FIG. 7A): this field indicates beam failure detection for the SpCell of this MAC entity. The SP field is set to 1 to indicate that a beam failure is detected for a SpCell only when a BFR MAC CE is to be included into a MAC PDU as a part of a random access (RA) procedure; otherwise, the SP field is set to 0.
Cᵢ (BFR MAC CE) (e.g., “C₁” to “C,” as shown in FIG. 7A): This field indicates beam failure detection in at least one TRP and the presence of an octet containing the AC field for the SCell with Serving Cell Index i. The Cᵢ field set to 1 indicates that beam failure for at least one TRP is detected, the evaluation of the candidate beams according to the requirements has been completed, and the octet containing the AC field is present for the SCell with Serving Cell Index i. The Cᵢ field set to 0 indicates that the beam failure is either not detected for all configured TRPs of this SCell or the beam failure is detected but the evaluation of the candidate beams according to the requirements has not been completed for all configured TRPs of this SCell. The octets containing the AC field are present in an ascending order based on the Serving Cell Index.
AC (e.g., “AC” as shown in the second row to the bottom row of FIG. 7A): This field indicates the presence of the Candidate RS ID field in this octet. If at least one of the SSBs or the CSI-RSs is available, the AC field is set to 1; otherwise, it is set to 0. If the AC field set to 1, the Candidate RS ID field is present. If the AC field set to 0, R bits are present instead.
TRP (e.g., “TRP” as shown in the second row to the bottom row of FIG. 7A): This field indicates TRP ID in which beam failure for this TRP is detected, and the evaluation of the candidate beams according to the requirements has been completed. TRP ID can be identified by a BFD-RS set or a CORESET pool.
SC (Same Cell) (e.g., “SC” as shown in the first column, the third row of FIG. 7A): This SC field indicates whether the next TRP is belonging to the same cell as previous one or not. This SC field can be one bit. In an example, if the SC field is set to 0, it means that the following TRP belongs to the same cell as the previous reported TRP. If the SC field is set to 1, it means that the following TRP belongs to the different cell from the previous reported TRP. In a further example, if the SC field is set to 1, it means that the following TRP belongs to the same cell as the previous reported TRP. If the SC field is set to 0, it means that the following TRP belongs to the different cell from the previous reported TRP.

Some embodiments of FIG. 7A assume that each cell of C₁ to C₇ is configured with two TRPs. It is contemplated that any other number of TRPs may be configured to each cell of C₁ to C₇ in some other embodiments.

In one embodiment of FIG. 7A, assuming that each cell of C to C₇ is configured with one or two TRPs, in a TRP based BFR MAC CE, C₁ and C₂ are set to 1, and other Cᵢ fields are set to 0. “TRP” in the second row of FIG. 7A is set to an ID of TRP #m which is associated with cell C₁. “SC” in the third row of FIG. 7A is set to 1 to mean that the following TRP belongs to a different cell from cell C₁. “TRP” in the third row of FIG. 7A is set to an ID of TRP #n which is associated with cell C₂. If two TRPs of cell C₂ are failed, “TRP” in the fourth row of FIG. 7A is set to an ID of TRP #n+1 which is associated with cell C₂.

In a further embodiment of FIG. 7A, assuming that each cell of C₁ to C₇ is configured with one or two TRPs, in a TRP based BFR MAC CE, C₁ and C₂ are set to 1, and other Cᵢ fields are set to 0. “TRP” in the second row of FIG. 7A is set to an ID of TRP #m which is associated with cell C₁. “SC” in the third row of FIG. 7A is set to 0 to mean that the following TRP belongs to the same cell as cell C₁. “TRP” in the third row of FIG. 7A is set to an ID of TRP #n which is associated with cell C₁. Since each of C₁ and C₂ is configured with two TRPs, “TRP” in the fourth row of FIG. 7A is associated with a different cell from cell C₁, i.e., cell C₂. That is, “TRP” in the fourth row of FIG. 7A may be set to an ID of TRP #n+1 which is associated with cell C₂. In the fifth row of FIG. 7A (not shown) may include “SC” field to mean that the following TRP belongs to the same cell or different cell from cell C₂.

FIG. 7B illustrates an exemplary format diagram of a TRP based BFR MAC CE with same cell indication and four octet Cᵢ field in accordance with some embodiments of the present application.

Similar to FIG. 7A, in the embodiments of FIG. 7B, TRP information will be included for the corresponding candidate RS ID, and information related to at least one TRP can be included in a TRP based BFR MAC CE. Fields in a TRP based BFR MAC CE as shown in IG. 7B are similar to those in FIG. 7A.

Similar to FIG. 7A, in one embodiment of FIG. 7B, assuming that each cell of C₁ to C₃₁ in the first to fourth rows of FIG. 7B is configured with one or two TRPs, in a TRP based BFR MAC CE, C₆, C₁₀, and C₃₀ are set to 1, and other Cᵢ fields are set to 0. “TRP” in the fifth row of FIG. 7B is set to an ID of TRP #m which is associated with cell C₆. “SC” in the sixth row of FIG. 7B is set to 1 to mean that the following TRP belongs to a different cell from cell C₆ i.e., C₁₀. “TRP” in the sixth row of FIG. 7B is set to an ID of TRP #n which is associated with cell C₁₀. If two TRPs of cell C₁₀ are failed, “TRP” in the seventh row of FIG. 7B is set to an ID of TRP #n+1 which is associated with cell C₁₀. Since each of C₁ to C₃₁ is configured with two TRPs, “TRP” in the eighth row of FIG. 7B (not shown) is associated with a different cell from cell C₁₀, i.e., cell C₃₀. That is, “TRP” in the eighth row of FIG. 7B may be set to an ID of TRP #y which is associated with cell C₃₀. If two TRPs of cell C₃₀ are failed, “TRP” in the ninth row of FIG. 7B (not shown) is set to an ID of TRP #n+1 which is associated with cell C₃₀. In the ninth row of FIG. 7B (not shown) may include “SC” field to mean that the following TRP belongs to the same cell or different cell from cell C₁₀.

FIG. 8 illustrates an exemplary format diagram of a TRP based BFR MAC CE with a total number of failed TRP(s) in accordance with some embodiments of the present application.

In the embodiments of FIG. 8, a new bitmap is used to indicate how many TRP for each cell with ‘1’ is failed. Fields in a TRP based BFR MAC CE as shown in FIG. 9 are similar to those in FIG. 7B. some fields in a TRP based BFR MAC CE as shown in FIG. 8 are defined as follows:
Ci (BFR MAC CE) (e.g., “C₁” to “C₃₁” as shown in FIG. 8): This field indicates beam failure detection in at least one TRP and the presence of an octet containing the AC field for the SCell with Serving Cell Index i. The Ci field set to 1 indicates that beam failure for at least one TRP is detected, the evaluation of the candidate beams according to the requirements has been completed, and the octet containing the AC field is present for the SCell with Serving Cell Index i. The Ci field set to 0 indicates that the beam failure is either not detected for all configured TRPs of this SCell or the beam failure is detected but the evaluation of the candidate beams according to the requirements has not been completed for all configured TRPs of this SCell. The octets containing the AC field are present in ascending order based on the Serving Cell Index.
AC (e.g., “AC” as shown in the ninth row to the bottom row of FIG. 8): This field indicates the presence of the Candidate RS ID field in this octet. If at least one of the SSBs or the CSI-RSs is available, the AC field is set to 1; otherwise, it is set to 0. If the AC field set to 1, the Candidate RS ID field is present. If the AC field set to 0, R bits are present instead.
TRP (e.g., “TRP” as shown in the ninth row to the bottom row of FIG. 8): This field indicates TRP ID in which a beam failure for this TRP is detected. TRP ID can be identified by BFD-RS set or CORESET pool.
Pᵢ (e.g., “P₀” to “P₃₁” as shown in the fifth row to the eighth row of FIG. 8): This Pᵢ field indicates the total number of TRP in which a beam failure is detected and the presence of an octet containing the AC field for the TRP of one SCell. If the beam failure is detected for this TRP, the evaluation of the candidate beams according to the requirements has been completed for the TRP, and the octet containing the AC field is present for the TRP of the SCell, this TRP can be accounted. If the beam failure of one TRP is either not detected or the beam failure is detected but the evaluation of the candidate beams according to the requirements has not been completed, and the octet containing the AC field is not present for the TRP of the SCell, this TRP will not be accounted.
   1) The Pᵢ field set to 1 indicates that information related to two TRPs will be included. The Pᵢ field set to 0 indicates that information related to one TRP is included. For example, if the Pᵢ field is set to 0, it means that one TRP is failed in the corresponding cell. If the Pᵢ field is set to 1, it means that two TRPs are failed in the corresponding cell.
   2) The Pᵢ is present in ascending order based on the Ci, which is equal to 1. For example, C₁, C₈ and C₁₀ are set to 1. Other Cᵢ is set to 0. The P₀, P₁ and P₂, which are associated with C₁, C₈ and C₁₀, respectively, are set to 1. R bits are present in the remaining five bits of one octet.

In an embodiment of FIG. 8, in a TRP based BFR MAC CE, C₁ and C₂₈ are set to 1, and other Cᵢ fields are set to 0. P₀ and P₁ in the fifth row of FIG. 8, which are associated with C₁ and C₂₈, are set 1. R bits are present in the remaining six bits of one octet in the fifth row of FIG. 8. P₀ set as 1 means that two TRPs are failed in C₁. “TRP” in the ninth and tenth rows of FIG. 8 are set to IDs of TRP #x and TRP #x+1 which are associated with the cell C₁. P₁ set as 1 means that two TRPs are failed in C₂₈. “TRP” in the eleventh and twelfth rows of FIG. 8 are set to IDs of TRP #n and TRP #n+1 which are associated with the cell C₂₈.

In a further embodiment of FIG. 8, in a TRP based BFR MAC CE, C₃, C₁₄, and C₂₄ are set to 1, and other Cᵢ fields are set to 0. P₀ and P₁ in the fifth row of FIG. 8, which are associated with C₃ and C₁₄, are set 1. P₂ in the fifth row of FIG. 8, which is associated with C₂₄, is set 0. R bits are present in the remaining five bits of one octet in the fifth row of FIG. 8. P₀ set as 1 means that two TRPs are failed in C₃. “TRP” in the ninth and tenth rows of FIG. 8 are set to IDs of TRP #x and TRP #x+1 which are associated with the cell C₃. P₁ set as 1 means that two TRPs are failed in C₁₄. “TRP” in the eleventh and twelfth rows of FIG. 8 are set to IDs of TRP #y and TRP #y+1 which are associated with the cell C₁₄. P₂ set as 0 means that one TRP are failed in C₂₄. “TRP” in the thirteenth rows of FIG. 8 is set to an ID of TRP #z which is associated with the cell C₂₄.

FIG. 9 illustrates an exemplary format diagram of a TRP based BFR MAC CE with a FI field in accordance with some embodiments of the present application.

In the embodiments of FIG. 9, all TRP information of each cell is included if this cell (e.g., C₁ in FIG. 9) is set as 1. Fields in a TRP based BFR MAC CE as shown in FIG. 9 are similar to those in FIG. 7B. A new field in a TRP based BFR MAC CE as shown in FIG. 9 is defined as follows:
FI (Failed Indication) (e.g., “FI” as shown in the eighth column, the first row of FIG. 9): This field indicates whether this TRP is failed or not. The FI for one TRP is set to 1 if the beam failure is detected for this TRP and the evaluation of the candidate beams according to the requirements has been completed for the TRP. The FI field set to 0 indicates that the beam failure is either not detected for this TRP of the SCell or the beam failure is detected but the evaluation of the candidate beams according to the requirements has not been completed for the TRP of this SCell. For example, if the FI field is set to 0, the indicted TRP of the cell means ‘not failed’; if the FI field is set to 1, the indicted TRP of the cell means ‘failed’; or vice versa.

In an embodiment of FIG. 9, in a TRP based BFR MAC CE, C₃, C₁₃, C₂₅, and C₃₁ are set to 1, and other Cᵢ fields are set to 0. “FI” in the fifth row of FIG. 9 is set to 0 to mean that TRP #0 which is associated with the cell C₃ is ‘not failed’. “FI” in the sixth row of FIG. 9 is set to 1 to mean that TRP #1 which is associated with the cell C₃ is ‘failed’. “FI” in the seventh row of FIG. 9 is set to 1 to mean that TRP #x which is associated with the cell C₁₃ is ‘failed’. “FI” in the eighth row of FIG. 9 is set to 1 to mean that TRP #x+1 which is associated with the cell C₁₃ is ‘failed’. “FI” in the ninth row of FIG. 9 is set to 1 to mean that TRP #y which is associated with the cell C₂₅ is ‘failed’. “FI” in the tenth row of FIG. 9 is set to 0 to mean that TRP #y+1 which is associated with the cell C₂₅ is ‘not failed’. “FI” in the eleventh row of FIG. 9 is set to 1 to mean that TRP #m which is associated with the cell C₃₁ is ‘failed’ “FI” in the twelfth row of FIG. 9 is set to 0 to mean that TRP #m+1 which is associated with the cell C₃₁ is ‘not failed’.

FIG. 10 illustrates an exemplary format diagram of a TRP based BFR MAC CE with or without TRP configuration in accordance with some embodiments of the present application.

In the embodiments of FIG. 10, two SCGs are configured for one DU, wherein one SCG is configured with TRP, and the other SCG is not configured with TRP. For example, the original formats in FIGS. 4 and 5 can be reused for a SCell without TRP configuration in the embodiments of FIG. 10, and the embodiments of FIGS. 7A and 7B including a “SC” field can be reused for a SCell with TRP configuration in the embodiments of FIG. 10.

In an embodiment of FIG. 10, SCG1 and SCG2 are configured for one DU, SCG1 is not configured with a TRP, and SCG2 is configured with TRP(s), and C₁ to C₃₁ for SCG1 and SCG2 are indicated in the first to fourth rows of FIG. 10. In a TRP based BFR MAC CE, C₃, C₁, C₁₄, C₂₁, and C₂₉ are set to 1, and other Cᵢ fields are set to 0. The fifth and sixth rows of FIG. 10 show information related to SCG1, which are of similar formats in FIGS. 4 and 5. The sixth to bottom rows of FIG. 10 show information related to failed TRP(s) configured to SCG2, which include “TRP” and “SC” field. The formats of the sixth to bottom rows of FIG. 10 may be similar to those in the embodiments of FIG. 7B.

The following texts describe specific Embodiments 1-4 of the methods as shown and illustrated in FIGS. 2-10. According to Embodiments 1-4, a UE and a BS may perform following operations. The UE may be UE1 as shown and illustrated in FIG. 1.

### Embodiment 1

(1) Step 1: A UE accesses a network. A serving cell of the UE is a SCell (or a SpCell).
(2) Step 2: The network, e.g., a PCell, transmits the configuration to the UE.
   One TRP or two TRPs for the serving cell are configured, e.g., TRP #0 and TRP #1 as shown in FIG. 1.
   A BFD-RS set is configured for each TRP. Each TRP is associated with a BFD-RS set. For example, BFD-RS set #0 is associated with TRP #0, and BFD-RS set #1 is associated with TRP #1.
   Independent configuration of a new beam identification RS (NBI-RS) set is per TRP if a NBI-RS set per TRP is configured, e.g., NBI-RS set #0 and NBI-RS set #1.
   A combination of BFD counter #0 and timer #0 in the MAC layer is configured for TRP #0. A combination of BFD counter #1 and timer #1 in the MAC layer is configured for TRP #1.
   One TRP may be described as one CORESET pool. For example, CORESET pool #0 is TRP #0.
(3) Step 3: The UE receives the configuration from the network, e.g., the PCell.
(4) Step 4: If a beam failure instance indication associated with TRP #0 has been received by the UE from lower layers, the MAC entity of the UE shall for each serving cell starts or restarts the timer for a beam failure detection (BFD) procedure associated with TRP #0, with an increment of COUNTER associated with TRP #0 by 1.
   COUNTER (per TRP) is a counter for the beam failure instance indication which is initially set to 0.
(5) Step 5: If COUNTER for TRP #0>=the Maximum Count for the beam failure instance indication and if the serving cell is the SCell, the UE triggers a BFR procedure for this TRP and transmits a BFR request, e.g., in a TRP based BFR MAC CE.
   Regarding a TRP based BFR MAC CE and the UE's corresponding behavior, the UE may adopt any of following Options 1-5 in different cases:
      Option 1: corresponding to the embodiments as shown in FIG. 6.
      Option 2: corresponding to the embodiments as shown in FIG. 7A or FIG. 7B.
      Option 3: corresponding to the embodiments as shown in FIG. 8.
      Option 4: corresponding to the embodiments as shown in FIG. 9.
      Option 5: corresponding to the embodiments as shown in FIG. 10.
(6) Step 6: The UE receives downlink control information (DCI) with toggled a new data indication (NDI) scheduling a same HARQ process ID as that of the PUSCH carrying the TRP based BFR MAC CE.

### Embodiment 2

(1) Step 1: A UE accesses a network. A serving cell of the UE is a SCell (or a SpCell).
(2) Step 2: The network, e.g., a PCell, transmits the configuration to the UE.
   One TRP or two TRPs for the serving cell are configured, e.g., TRP #0 and TRP #1 as shown in FIG. 1.
   A BFD-RS set is configured for each TRP. Each TRP is associated with a BFD-RS set. For example, BFD-RS set #0 and BFD-RS set #1 are associated with TRP #0 and TRP #1, respectively.
   Independent configuration of a NBI-RS set is per TRP if the NBI-RS set per TRP is configured, e.g., NBI-RS set #0 and NBI-RS set #1.
   A combination of BFD counter #0 and timer #0 in the MAC layer is configured for TRP #0. A combination of BFD counter #1 and timer #1 in the MAC layer is configured for TRP #1.
   One TRP may be identified by one CORESET pool besides the BFD-RS set. For example, CORESET pool #0 is TRP #0.
(3) Step 3: The UE receives the configuration from the network, e.g., the PCell.
(4) Step 4: If a beam failure instance indication associated with TRP #0 has been received by the UE from lower layers, the MAC entity of the UE shall for each serving cell starts or restarts the timer for beam failure detection associated with TRP #0, with an increment COUNTER associated with TRP #0 by 1.
   COUNTER (per TRP) is a counter for the beam failure instance indication which is initially set to 0
(5) Step 5: If COUNTER for TRP #0>=the Maximum Count for the beam failure instance indication and if the serving cell is the SCell, the UE triggers a BFR procedure for this TRP, i.e., the 1st failed TRP.
   The UE generates a TRP based BFR MAC CE triggered by detecting the beam failure of the 1st failed TRP.
(6) Step 6: The beam failure of the 2nd TRP is detected before transmitting the BFR request for the 1st failed TRP.
   The UE triggers a further BFR procedure for the 2nd TRP.
   The further BFR procedure determines that: at least one TRP based BFR procedure for the 1st failed TRP of one cell has been triggered; and a TRP based BFR request for the 1st failed TRP for the SCell or the SpCell, for which an evaluation of the candidate beams according to the requirements has been completed, has not been cancelled.
(7) Step 7: The UE transmits the BFR request, e.g., in a TRP based BFR MAC CE.
   Case 1-1: If UL grant can accommodate two TRP based BFR MAC CEs:
      If only information related to one TRP is included in the BFR request, e.g., a TRP based BFR MAC CE (for example, if beam failures of both TRPs are detected at the same time and a cell specific BFR procedure is configured, the UE may perform a RA procedure for a BFR purpose), two TRP based BFR MAC CEs are generated. When one TRP based BFR MAC CE is transmitted, another one will not be cancelled. Two different BFR MAC CEs can be included in one PDU.
   Case 1-2: If UL grant can accommodate one TRP based BFR MAC CE:
      The UE selects one TRP based BFR MAC CE. A TRP based BFR MAC CE including a new beam can prioritize over a TRP based BFR MAC CE without a new beam.

### Embodiment 3

(1) Step 1: A UE accesses a network. A serving cell of the UE is a SCell (or a SpCell).
(2) Step 2: The network, e.g., a PCell, transmits the configuration to the UE.
   One TRP or two TRPs for the serving cell are configured, e.g., TRP #0 and TRP #1 as shown in FIG. 1.
   A BFD-RS set is configured for each TRP, and each TRP is associated with a BFD-RS set. For example, both BFD-RS set #0 and BFD-RS set #1 are associated with TRP #0 and TRP #1, respectively.
   Independent configuration of a NBI-RS set is per TRP if the NBI-RS set per TRP is configured, e.g., NBI-RS set #0 and NBI-RS set #1.
   A combination of BFD counter #0 and timer #0 in the MAC layer is configured for TRP #0. A combination of BFD counter #1 and timer #1 in the MAC layer is configured for TRP #1.
   One TRP may be identified by one CORESET pool besides BFD-RS set. For example, CORESET pool #0 is the TRP #0.
(3) Step 3: The UE receives the configuration from the network, e.g., the PCell.
(4) Step 4: If a beam failure instance indication associated with TRP #0 has been received by the UE from lower layers, the MAC entity of the UE shall for each serving cell starts or restarts the timer for beam failure detection associated with TRP #0, with an increment COUNTER associated with TRP #0 by 1.
   COUNTER (per TRP) is a counter for the beam failure instance indication which is initially set to 0
(5) Step 5: If COUNTER for TRP #0>=the Maximum Count for the beam failure instance indication and if the serving cell is the SCell, the UE triggers a BFR procedure for this TRP.
   The UE generates a TRP based BFR MAC CE triggered by detecting the beam failure of this TRP.
(6) Step 6: The beam failure of the 2nd TRP is detected before transmitting beam failure recovery request for the first failed TRP.
   The UE triggers a further BFR procedure for the 2nd TRP.
   The further BFR procedure determines that: at least one TRP based BFR procedure for the 1st failed TRP of one cell has been triggered; and a TRP based BFR request for the 1st failed TRP for the SCell or the SpCell, for which an evaluation of the candidate beams according to the requirements has been completed, has not been cancelled.
(7) Step 7: The UE transmit a BFR request, e.g., in a TRP based BFR MAC CE.
   Case 2: information related to two TRPs can be included in a TRP based BFR MAC CE (for example, the UE may adopt any of Options 2-5 in Step 5 of Embodiment 1).
      If information related to two or more TRPs can be included in a TRP based BFR MAC CE, the 2nd TRP based BFR MAC CE should be prioritized for transmission if the 1st TRP based BFR MAC CE is not cancelled.
      When the 2nd TRP based BFR MAC CE including information related to both TRPs is transmitted, the 1st TRP based BFR MAC CE associated with the same cell can be cancelled. If the 1st TRP based BFR MAC CE is transmitted, the 2nd TRP based BFR MAC CE cannot be cancelled.
      When the 2nd TRP based BFR MAC CE of one SCell is triggered, the 1st TRP based BFR MAC CE of the same SCell can be cancelled.

### Embodiment 4

(1) Step 1: A UE accesses a network. A serving cell of the UE is a PCell or a PSCell.
(2) Step 2: The network, e.g., the PCell, transmits the configuration to the UE.
   One TRP or two TRPs for the serving cell are configured, e.g., TRP #0 and TRP #1 as shown in FIG. 1.
   A BFD-RS set is configured for each TRP. Each TRP is associated with a BFD-RS set. For example, both BFD-RS set #0 and BFD-RS set #1 are associated with TRP #0 and TRP #1, respectively.
   Independent configuration of a NBI-RS set is per TRP if the NBI-RS set per TRP is configured, e.g., NBI-RS set #0 and NBI-RS set #1.
   A combination of BFD counter #0 and timer #0 in the MAC layer is configured for TRP #0. A combination of BFD counter #1 and timer #1 in the MAC layer is configured for TRP #1.
   One TRP may be identified by one CORESET pool besides the BFD-RS set. For example, CORESET pool #0 is the TRP #0.
(3) Step 3: The UE receives the configuration from the network, e.g., the PCell.
(4) Step 4: If a beam failure instance indication associated with TRP #0 has been received by the UE from lower layers, the MAC entity of the UE shall for each serving cell starts or restarts the timer for beam failure detection associated with TRP #0, with an increment COUNTER associated with TRP #0 by 1.
   COUNTER (per TRP) is a counter for the beam failure instance indication which is initially set to 0
(5) Step 5: If COUNTER for TRP #0>=the Maximum Count for the beam failure instance indication and if the serving cell is the PCell or the PSCell, the UE triggers a BFR procedure for this TRP, i.e., the 1st failed TRP.
   The UE generates a TRP based BFR MAC CE triggered by detecting the beam failure of this TRP.
(6) Step 6: A beam failure of the 2nd TRP is detected before transmitting the BFR request for the 1st failed TRP.
   The UE triggers a further BFR procedure for the 2nd TRP.
   The further BFR procedure determines that: at least one TRP based BFR procedure for the 1st failed TRP of one cell has been triggered; and a TRP based BFR request for the PCell or the PSCell, for which an evaluation of the candidate beams according to the requirements has been completed, has not been cancelled.
(7) Step 7: The UE transmit a BFR request, e.g., a TRP based BFR MAC CE.
   Option 1: If beam failures of both TRPs are detected at the same time and a cell specific BFR procedure is configured, the UE performs a RA operation for the BFR procedure.
      Association between each BFD-RS set and a RS set for a BFR procedure should be configured. When the UE performs the RA operation for the BFR procedure in the serving cell because of detecting beam failures of both TRPs, the UE needs to select the suitable beam among the configured RS set for a recovery purpose associated with the BFD-RS set.
   Option 2: If beam failures of both TRPs are detected at the same time and a cell specific BFR procedure is not configured, the UE detects a radio link failure (RLF) and performs a RRC re-establishment procedure.
      The network needs to differentiate the failure type of two TRP failures at the same time from the case that a response for a BFR MAC CE is not received. For example, one new failure type (e.g., beam failures of two TRPs are detected) should be added in the MCG failure information message associated with a fast MCG link recovery procedure.
   Option 3: If beam failures of both TRPs are detected at the same time, a TRP based BFR MAC CE can be transmitted to the network via any available serving cell. The UE needs to monitor a PDCCH within a period. If a response is received, the UE considers that the BFR procedure is successful. Otherwise, the UE performs a RRC re-establishment procedure.

FIG. 11 illustrates an exemplary block diagram of an apparatus according to some embodiments of the present application. As shown in FIG. 11, the apparatus 1100 may include at least one processor 1104 and at least one transceiver 1102 coupled to the processor 1104. The apparatus 1100 may be a UE or a network device (e.g., a TRP or a BS).

Although in this figure, elements such as the at least one transceiver 1102 and processor 1104 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE. The transceiver 1102 in the UE may be configured to receive, from a serving cell, configuration information related to at least one TRP of the serving cell. The processor 1104 may be configured to detect a beam failure of a TRP and to trigger a BFR procedure, wherein the BFR procedure includes transmitting a BFR request to the serving cell, and wherein the BFR request includes information per TRP associated with the at least one TRP of the serving cell.

In some embodiments of the present application, the apparatus 1100 may be a network device (e.g., a BS). The transceiver 1102 in the network device may be configured: to transmit, to a user equipment (UE), configuration information related to at least one TRP of a serving cell of the UE; and to receive a BFR request from the UE, wherein the BFR request includes information per TRP associated with the at least one TRP.

In some embodiments of the present application, the apparatus 1100 may further include at least one non-transitory computer-readable medium. In some embodiments of the present disclosure, the non-transitory computer-readable medium may have stored thereon computer-executable instructions to cause a processor to implement the method with respect to a UE or a network device (e.g., a TRP or a BS) as described above. For example, the computer-executable instructions, when executed, cause the processor 1104 interacting with transceiver 1102, so as to perform operations of the methods, e.g., as described in view of any of FIGS. 2-10.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A method performed by a user equipment (UE), comprising:
receiving, from a serving cell, configuration information related to at least one transmission reception point (TRP) of the serving cell;
detecting a first beam failure of a first TRP; and
triggering a first beam failure recovery (BFR) procedure, wherein the first BFR procedure includes transmitting a first BFR request to the serving cell, and wherein the first BFR request includes information per TRP associated with the at least one TRP of the serving cell.

2-14. (canceled)

15. A user equipment (UE), comprising:
at least one memory; and
at least one processor coupled with the at least one memory and configured to cause the UE to:
receive, from a serving cell,
configuration information related to at least one transmission reception point (TRP) of the serving cell;
detect a beam failure of a first TRP; and
trigger a beam failure recovery (BFR) procedure that includes transmitting a first BFR request to the serving cell, the first BFR request including information per TRP associated with the at least one TRP of the serving cell.

16. The UE of claim 15, wherein the first BFR request includes information related to the first TRP, and the first BFR request is included in a first medium access control (MAC) control element (CE).

17. The UE of claim 15, wherein the configuration information is related to at least two TRPs of the serving cell, and the at least one processor is configured to cause the UE to:
detect a second beam failure of a second TRP before the first BFR request is transmitted to the serving cell; and
trigger a second BFR procedure that includes a second BFR request being transmitted to the serving cell.

18. The UE of claim 17, wherein the serving cell is one of a secondary cell (SCell), a primary cell (PCell), or a primary cell of a second cell group (PSCell).

19. The UE of claim 18, wherein the serving cell is the PCell or the PSCell, and the configuration information related to the at least two TRPs includes:
a first association relationship between a first beam failure detection reference signal (BFD-RS) set configured for the first TRP, and a reference signal (RS) set for a random access (RA) for a BFR procedure; and
a second association relationship between a second BFD-RS set configured for the second TRP, and the RS set for the RA for the BFR procedure.

20. The UE of claim 18, wherein the serving cell is the PCell or the PSCell, and the at least one processor is configured to cause the UE to transmit at least one of the first BFR request or the second BFR request via an available serving cell.

21. The UE of claim 18, wherein the serving cell is the PCell or the PSCell, and the at least one processor is configured to cause the UE to monitor a physical downlink control channel (PDCCH) within a period.

22. The UE of claim 21, wherein:
the BFR procedure for the serving cell is successful in response to receiving the PDCCH within the period and based on the PDCCH including a same hybrid automatic repeat request (HARQ) process identifier (ID) as a physical uplink share channel (PUSCH) carrying a BFR MAC-CE; or
the at least one processor is configured to cause the UE to perform a radio resource control (RRC) re-establishment procedure for the serving cell in response to not receiving the PDCCH within the period.

23. The UE of claim 17, wherein the second BFR request is included in a second MAC CE, and wherein the second BFR request includes information related to a failed TRP among the first TRP and the second TRP.

24. The UE of claim 23, wherein both a first MAC CE and the second MAC CE can be included in one packet data unit (PDU).

25. The UE of claim 23, wherein based on the second TRP being the failed TRP and the second BFR request including information related to the second TRP, the at least one processor is configured to cause the UE to one of:
transmit the first BFR request without canceling the second BFR request;
transmit the second BFR request without canceling the first BFR request;
transmit the first BFR request and cancel the second BFR request based on the first BFR request having a higher priority level than the second BFR request; or
transmit the second BFR request and cancel the first BFR request based on the second BFR request having a higher priority level than the first BFR request.

26. The UE of claim 23, wherein based on both the first TRP and the second TRP being the failed TRP, and the second BFR request including information related to the first TRP and information related to the second TRP, the at least one processor is configured to cause the UE to one of:
transmit the second BFR request without canceling the first BFR request in response to triggering the second BFR procedure;
transmit the second BFR request and cancel the first BFR request in response to triggering the second BFR procedure; or
transmit the first BFR request without canceling the second BFR request.

27. The UE of claim 26, wherein the second BFR request is transmitted without canceling the first BFR request based on the second BFR request having a higher priority level than the first BFR request.

28. The UE of claim 15, wherein the first BFR request includes at least one of:
a first field as a TRP identifier (ID);
a second field as a total number of one or more TRPs occurring a beam failure;
a third field indicating whether a TRP is failed or not; or
a fourth field indicating whether a subsequent TRP in a MAC CE of the first BFR request is associated with a same cell as a previous TRP in the MAC CE or not.

29. A processor for wireless communication, comprising:
at least one controller coupled with at least one memory and configured to cause the processor to:
receive, from a serving cell, configuration information related to at least one transmission reception point (TRP) of the serving cell;
detect a beam failure of a TRP; and
trigger a beam failure recovery (BFR) procedure that includes transmitting a BFR request to the serving cell, the BFR request including information per TRP associated with the at least one TRP of the serving cell.

30. A network equipment (NE) for wireless communication, comprising:
at least one memory; and
at least one processor coupled with the at least one memory and configured to cause the NE to:
transmit, to a user equipment (UE), configuration information related to at least one transmission reception point (TRP) of a serving cell of the UE; and
receive a beam failure recovery (BFR) request from the UE, the BFR request including information per TRP associated with the at least one TRP of the serving cell.

31. The NE of claim 30, wherein the configuration information is related to at least two TRPs of the serving cell, the BFR request included in a medium access control (MAC) control element (CE), and the BFR request including information related to a failed TRP among the at least two TRPs.

32. The NE of claim 30, wherein the BFR request includes at least one of:
a first field as a TRP identifier (ID);
a second field as a total number of one or more TRPs occurring a beam failure;
a third field indicating whether a TRP is failed or not; or
a fourth field indicating whether a subsequent TRP in a medium access control (MAC) control element (CE) of the BFR request is associated with a same cell as a previous TRP in the MAC CE or not.

33. The NE of claim 30, wherein the at least one processor is configured to cause the NE to:
transmit, to the UE, the configuration information related to two secondary cell groups (SCGs) that are configured for one distributed unit (DU); and
in response to one SCG within the two SCGs being configured as a TRP, a medium access control (MAC) control element (CE) is associated with one or more serving cells of the one SCG; or
in response to each SCG of the two SCGs being configured as the TRP, the MAC CE is associated with the one or more serving cells of the each SCG of the two SCGs.
